(19) United States
(12) Patent Application Publication
(10) Pub. No.: US 2010/0125496 A1
(43) Pub. Date: May 20, 2010

(54) SYSTEM AND METHOD FOR AUTOMATED GENERATION OF ADVERTISING

(76) Inventor: Victor K. Wong, New Haven, CT (US)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/622,367

(22) Filed: Nov. 19, 2009

Related U.S. Application Data
(60) Provisional application No. 61/116,123, filed on Nov. 19, 2008.
(60) Provisional application No. 61/116,117, filed on Nov. 19, 2008.

(51) Int. Cl. G06Q 30/00; G06Q 10/00; G06F 17/30

(52) U.S. Cl. 705/14.25; 705/14.54; 705/347; 707/769; 707/754; 707/E17.017

(57) ABSTRACT

A method for searching a computer network using a descriptor for a topic, for sources that may have content concerning the topic, is provided. The method further includes searching a source for content concerning said topic and filtering the content to obtain filtered information of particular relevance for marketing purposes. The method further includes preparing a report using the filtered information if the content includes the filtered information. The topic is a business, an organization, a product, a creative work, a service, a person, or an event. The report is an advertisement, website, or marketing material related to the topic.

This application claims the benefit of U.S. Provisional Patent Application Ser. No. 61/116,123 and U.S. Provisional Patent Application Ser. No. 61/116,117, both filed on Nov. 19, 2008, the contents of which are incorporated by reference herein.

### BACKGROUND OF THE INVENTION

1. Field of the Invention

The present disclosure relates to a system and method for generating print advertisements, online advertisements, brochures, pamphlets, websites, flyers, videos, etc. (“Marketing Materials”). More particularly, the present disclosure relates to a system and method for generating Marketing Materials automatically after inputting identifying information about a business. Among other uses, the system may be used to automate design aspects of Marketing Materials.

2. Description of Related Art

As the Internet continues to develop, business are seeking opportunities to use on-line tools to easily develop Marketing Materials. Many websites make available awards, promotions, photos, logos, contact information, industry information, hours of operation, keywords, price ranges, credit cards accepted, business description, and other details relating to a business (“Business Content”). Business Content may also include stock photography, audio, and visual materials determined to be relevant to a business. Further, Business Content may also include editorial content, including professional reviews of a business, user-generated reviews, aggregate ratings, business rankings, etc. (“Reviews”). Such Business Content can take the form of text, images, audio, or video.

While many websites make available such Business Content, there does not exist a website or a system made available by a website across a computer network that would enable a user to easily and efficiently generate Marketing Materials for a business using the Business Content. And in particular, a website that would permit users to generate Marketing Materials using selected Business Content that is determined to portray the business most favorably (“Selected Marketable Content”), for example the best or most positive Reviews of a business.

Accordingly, there is a need for a system and a software system that searches disparate sources that contain Business Content, such as websites, databases, structured data feeds, and stock photography repositories, which may be internal or maintained by third parties (“Content Sources”). Such Business Content is then filtered or manipulated using predefined filtering criteria to quantitatively and qualitatively identify Selected Marketable Content for the purpose of helping a user generate Marketing Materials for a business. A user can be a person such as a sales representative, designer, or business owner, for example.

### SUMMARY OF THE DISCLOSURE

The present disclosure provides a software system and method for automatically generating Marketing Materials for a business by receiving identifying information about the business from a user. The software system automatically searches a plurality of Content Sources for Business Content related to the business, and filters said Business Content based on pre-defined criteria to generate Marketing Materials.

The present disclosure further provides for a method that uses identifying information from the user to generate a standardized name and location of the business to compile a list of Content Sources that may have Business Content related to the business.

The present disclosure also provides for a method that searches the list of Content Sources for Business Content using identifying information to retrieve Business Content related to the business. The Business Content is then filtered using pre-defined criteria to identify Selected Marketable Content for use in Marketing Materials.

These and other objects and advantages of the present invention are provided by a method that includes searching a computer network using a descriptor for a topic, for Content Sources that may have Business Content concerning the topic. The method further includes determining whether the Content Source includes Business Content of the topic; and preparing a report using the Business Content if the Content Source includes Business Content.

A system including a processor that performs a method that includes: a) searching a computer network using a descriptor for a topic, for Content Sources that may have Business Content concerning said topic; b) determining whether said Content Sources include Business Content of said topic; and c) preparing a report using said Business Content if said Content Source includes said Business Content.

A computer readable storage medium having stored therein instructions for generating Marketing Materials including searching a computer network using a descriptor for a topic, for Content Sources that may have Business Content concerning the topic; determining whether the Content Sources includes Business Content of the topic; and preparing a report using the Business Content if the Content Source includes Business Content.

### BRIEF DESCRIPTION OF THE DRAWINGS

The foregoing will be more apparent from the following detailed explanation of the preferred embodiments of the invention in connection with the accompanying drawings.

FIG. 1 illustrates a hardware and software system for carrying out the method of the present disclosure;

FIG. 2 is a flowchart illustrating the steps of method for generating Marketing Materials using the system of FIG. 1;

FIG. 3 illustrates the steps of method for searching a Content Source from flow chart of FIG. 2;

FIG. 4 illustrates an example of a screen shot that the system of FIG. 1 generates to receive input from a user;

FIG. 5 illustrates an example of a screen shot that the system of FIG. 1 presents to the user to enable the user to confirm a business identity;

FIG. 6 illustrates an example of an advertisement generated by the system of FIG. 1;

FIG. 7 illustrates an example of a screen shot that allows a user to edit or delete photographs and graphic that would appear on advertisement created by system of FIG. 1;

FIG. 8 illustrates an example of a screen shot that allows a user to edit or remove text from Reviews obtained by the system of FIG. 1; and

FIG. 9 illustrates an example of a website that is created using method of FIG. 2, according to the present invention.

### DETAILED DESCRIPTION OF THE INVENTION

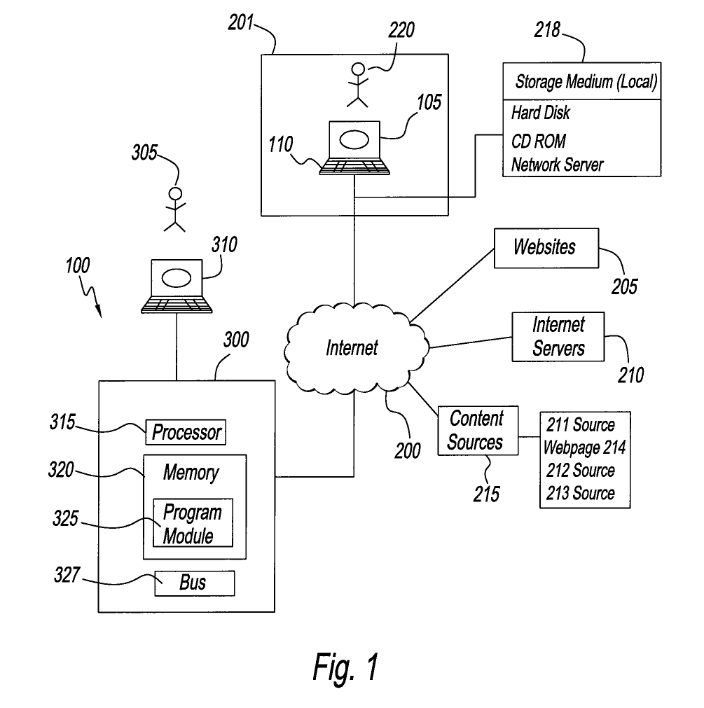

Referring to the drawings and in particular to FIG. 1, a block diagram of the system of the present disclosure is shown and generally referenced by reference numeral 100. System 100 includes a computer system 300. An operator 305 is able to program computer 300. Computer system 300 includes a user interface 310, a processor 315, memory 320, and a bus 327. Computer 300 may be implemented on a general-purpose microcomputer. Processor 315 is configured of logic circuitry that responds to and executes instructions. Memory 320 stores data and instructions for controlling the operation of processor 315. Memory 320 may be implemented in a random access memory (RAM), a hard drive, a read only memory (ROM), or a combination thereof. One of the components of memory 320 is a program module 325.

Program module 325 contains instructions for controlling processor 315 to execute the methods described herein. For example, as a result of execution of program module 325, processor 315 is able to receive instructions/input from a user 220, search computer network 200 (e.g. Internet) using input and retrieve a list of sources from computer network 200 that is used to generate a report such as an advertisement. The term “module” is used herein to denote a functional operation that may be embodied either as a stand-alone component or as an integrated configuration of a plurality of sub-ordinate components. Thus, program module 325 may be implemented as a single module or as a plurality of modules that operate in cooperation with one another. Moreover, although program module 325 is described herein as being installed in memory 320, and therefore being implemented in software, it could be implemented in any hardware (e.g., electronic circuitry), firmware, software, or a combination thereof.

User 220 has access to system 100 via a computer network 200, as shown, or from a server. User 220 may be a sales person at a media company, an employee at a business 201, a business owner, or other person who may be otherwise charged with preparing Marketing Materials for business 201, such as a graphic designer. User 220 accesses system 100 using a computer 105 having a user interface 110. Computer 105 is coupled to and has access to system 100 via a network 200. Computer 105 also has associated therewith local storage mediums 218.

Network 200 provides access to websites 205, internet servers 210 and various Content Sources 215, for example. Computer 105 includes an input device such as a keyboard or speech recognition subsystem for enabling a user to communicate information and command selections through network 200 to processor 315. User interface 110 also includes an output device such as a display or a printer. A cursor control such as a mouse, track-ball, or joy stick, allows the user to manipulate a cursor on the display for communicating additional information and command selections through network 200 to processor 315. User interface may also be a personal digital assistant (PDA), or the like.

User interface 110 and computer 105 are able to access program module 325 of computer system 300 from network 200. Operator 305 makes program module 325 available to user 220 via network 200 from, for example, a website.

Referring to flow chart 390, a method 400 of the present disclosure is provided. User 220 accesses system 100 via network 200. In step 405, after the start, system 100 prompts user 220 to enter information related to business 201, such as a business name and/or location, into a field on a screen. The location of business can be a segment of a business location, such as a street address, a postal code, a state/region, or any combination thereof (“Location Input”). Such information is preferably entered by user 220 via user interface 110.

In step 410, processor 315 searches various sources that contain standardized business names and locations. In step 410, process searches using information provided by user 220 in step 405. Step 410 results in a standardized business name and location, or if none is found, a descriptor of such business that was provided by user in step 405.

In step 415, system 100 prompts user with a screen that permits user 220 to confirm a match of business 201 with the result of step 410. This step is an optional step. System 100 can progress from step 410 directly to step 420.

In step 420, system 100 searches network 200 and compiles a list of Content Sources using descriptor. Based on descriptor, system is able to obtain and compile a list of Content Sources that may contain Business Content related to business 201.

Content Sources are preferably one or a plurality of websites identified by one or a plurality of Uniform Resource Locators (URLs), that could—but do not necessarily need to—include geographic information or industry specific information. For example, if user 220 is generating Marketing Materials for a law firm in Chicago, step 420 could provide legal-related Content Sources, Chicago-related Content Sources, and other Content Sources for subsequent searching. Alternatively, were user 220 developing Marketing Materials for a sushi restaurant in Denver, processor 315 could search computer network 200 for a list of Content Sources directed to that type of food, Denver-related Content Sources, and other Content Sources.

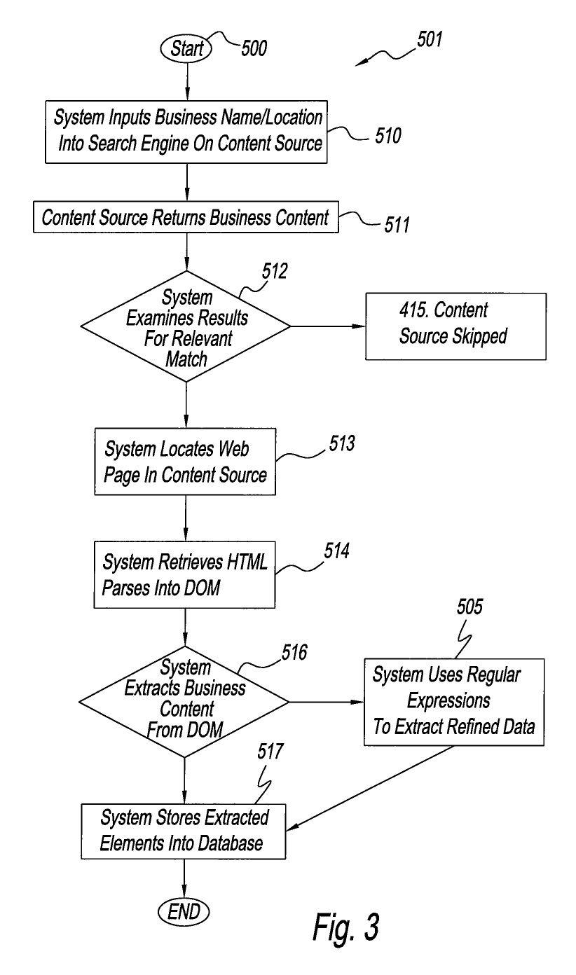

In step 430, system 100 searches Content Sources compiled in step 420 based on descriptor for Business Content. For example, images, audio, and video can be searched based on attributes including size, quality, filename, and position on website, for example. Step 430 may also identify hypertext links that point to other Content Sources, and such Content Sources may also be searched. Referring to FIG. 3, a flowchart 500 is provided to illustrate a method 501 of searching a Content Source 211, specifically, a structured website or directory. Source 211 has a particular standardized structure for listings contained therein.

In step 430, searches are preferably conducted in parallel to search all Content Sources compiled in step 420 for Business Content.

In step 510, processor 315 uses search functionality on Content Source 211 to search using business name and/or Location Input.

In step 511, Content Source 211 returns a list of results.

In step 512, system examines results for match.

In step 513, system locates webpage 214 relating to business provided in step 510.

In step 514, system 100 retrieves hypertext markup language (HTML) from webpage 214. HTML is analyzed and parsed into a Document Object

Model (DOM) so that specific elements can be retrieved more easily. In step 514, webpage 214 is organized based on a specific template. When system 100 searches Content Source 211 for a business 201, specific rules are used to obtain information from the standardized structure of Content Source 211, for example. Based on specific rules structured for 211, processor 315 is able to return accurate and specific results related to business 201 based on inputted information from step 510.

For example, Content Source 211 may store business hours within a DOM node with an ID “Operating Hours.” For Content Source 211, processor 315 is instructed to search the DOM and retrieve the hours from that particular node. Each Content Source 211, 212 and 213 has its own particular structure, processor is instructed to search each Content Source 211, 212 and 213 with a specific set of instructions to navigate through the DOM.

Search of Content Source 211 might include a search to locate text that would indicate a promotion, such as “$5 off” or “20% off.”

In step 516, process extracts specific Business Content from DOM.

Step 505 is an optional step. In step 505, regular expressions are used to extract refined data.

In step 517, process stores elements extracted from DOM into database.

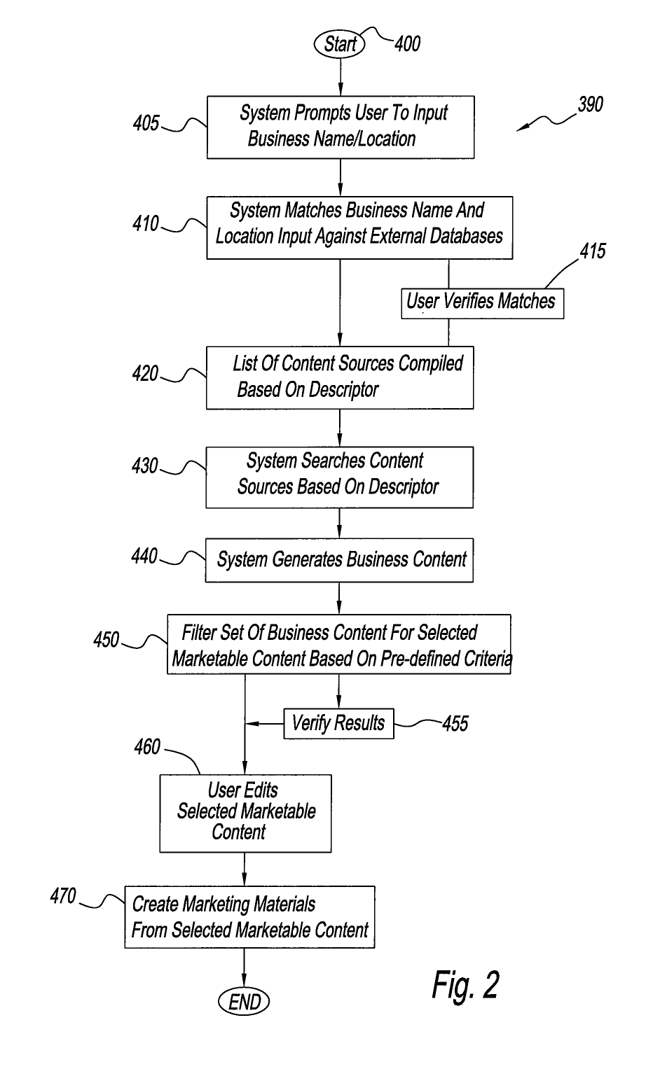

Referring again to FIG. 2, step 430 is a loop and repeats throughout method 400 to continuously identify and search for Content Sources. In step 440, system 100 generates a set of results that includes Business Content related to business 201. The results are supplemented by searching Content Sources, such as repositories of stock photography, that are identified as relevant to the business using the industry information of the business, as determined in step 430.

In step 450, results of step 440 are filtered or manipulated based on predefined criteria to refine results of step 440. Predefined criteria are created by operator 305. Operator 305 has programmed processor 315 to execute instructions to generate a result based on predefined criteria. Step 450 is a filter that uses quantitative and qualitative analysis to discard negative Business Content and identify Selected Marketable Content from the set of results of step 440.

Accordingly, Reviews are filtered quantitatively and qualitatively. Processor 315 can filter Reviews qualitatively by searching for particular keywords, phrases, or sentiments—both positive and negative—within the content of the Review. For example, step 450 may search for positive words or phrases such as “best,” “excellent,” or “best of my life” and/or negative words or phrases such as “rodent,” “worst,” or “bland.” Processor 315 may also use other semantic techniques to analyze the content of the Reviews and identify Selected Marketable Content for inclusion in Marketing Materials.

Reviews may also be searched based upon any quantitative information that may be contained therein. For example, a Review containing a five-star rating would classify the review as Selected Marketable Content for inclusion in Marketing Materials.

Similarly, images, audio, and visual materials can be filtered based on factors such as size, quality, position, filename, extension, and format. For example, such a filter could identify the logo of the business based its filename, size, and position on a website.

Optionally, step 455 searches the set of results from step 440 to verify that inputs of step 405 are associated with results of step 440. Step 455 is executed based upon an algorithm such as the Levenshtein distance that would define an acceptable proximity of the results to the user inputs of step 405.

In step 460, user has the opportunity to edit, remove, order, and supplement the Selected Marketable Content from step 450. This is an optional step.

In step 470, system 100 creates Marketing Materials from Selected Marketable Content and process ends. The Selected Marketable Content is arranged according to predetermined templates designed for each form of Marketing Material. Depending on the format, Marketing Materials may be static or animated. Depending on the format, Selected Marketable Content may be displayed in order of its determined marketability, and/or prioritized based upon the Content Source from which it is obtained, or the frequency with which it is found in disparate Content Sources. Marketability is defined as suitability for use in Marketing Materials. Within a single format, for example, online advertisements, the Marketing Materials created may take different sizes and types. The contents, design, format, shape, size, Selected Marketable Content within, and other attributes of the Marketing Materials can be edited by user 220.

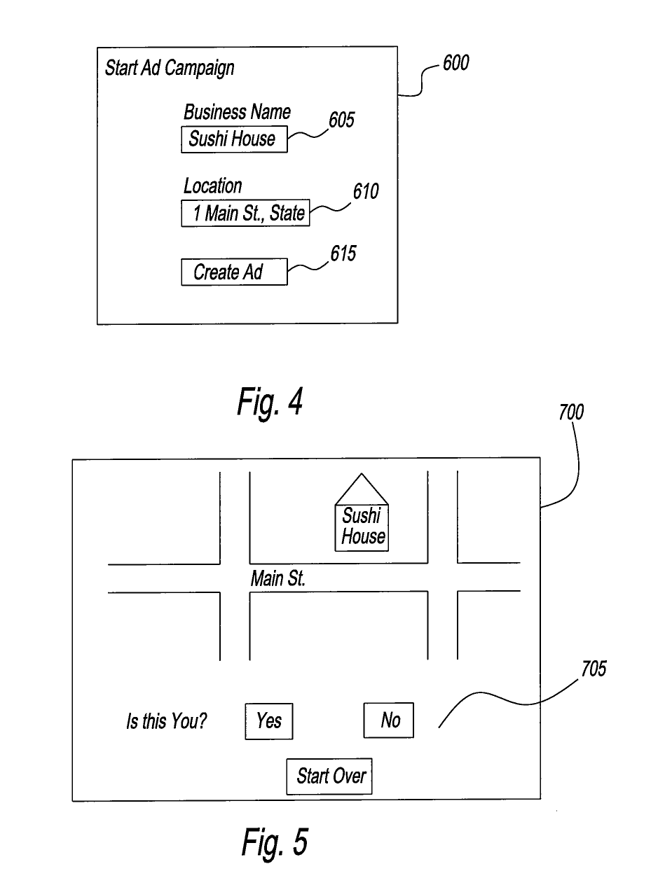

Referring to FIG. 4, an example of a screen 600 is provided. System 100 presents user 220 with a screen 600 provided with fields 605 and 610 to receive inputs and button 615 to submit the inputs. In field 605 user inputs business name and in field 610 user inputs business Location Input. User would then start search by moving cursor over button 615 using mouse and pressing button 615, for example. FIG. 4 corresponds to step 405.

Referring to FIG. 5, system 100 presents user with screen 700 having a map 705 based on the inputs received in fields 605 and 610. User 220 is prompted to confirm the business based upon the results presented. FIG. 5 corresponds to step 415.

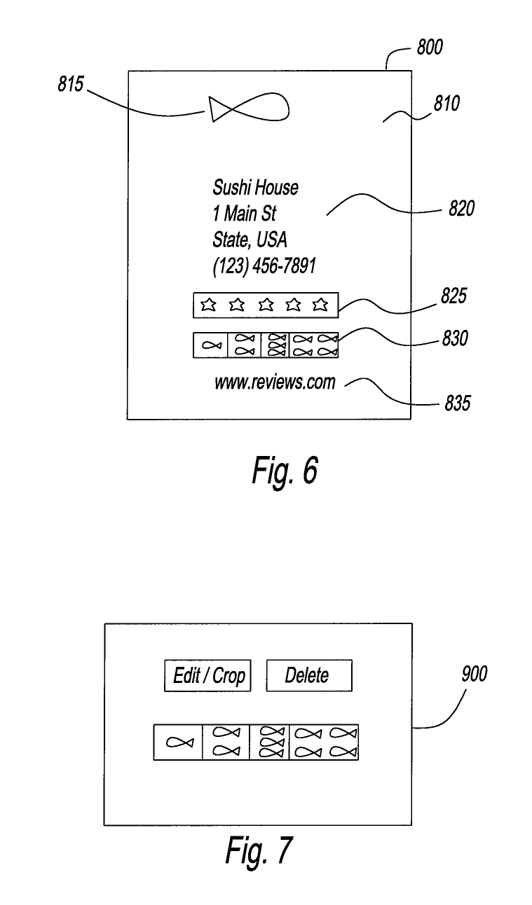

In FIG. 6, as an example of Marketing Material, an advertisement 810 is presented to user 220 in screen 800. Advertisement 810 may include logo 815, address 820, a symbolic rating 825, and various FIGS. 830. While FIG. 6 illustrates an advertisement, it will be understood that system 100 could also create other forms of Marketing Materials. Furthermore, advertisement 810 could also contain a hypertext link 835 to other Business Content that offers further information about the business to a potential patron.

FIG. 7 shows a screen 900 having graphics that are presented to user 220 for editing or deleting.

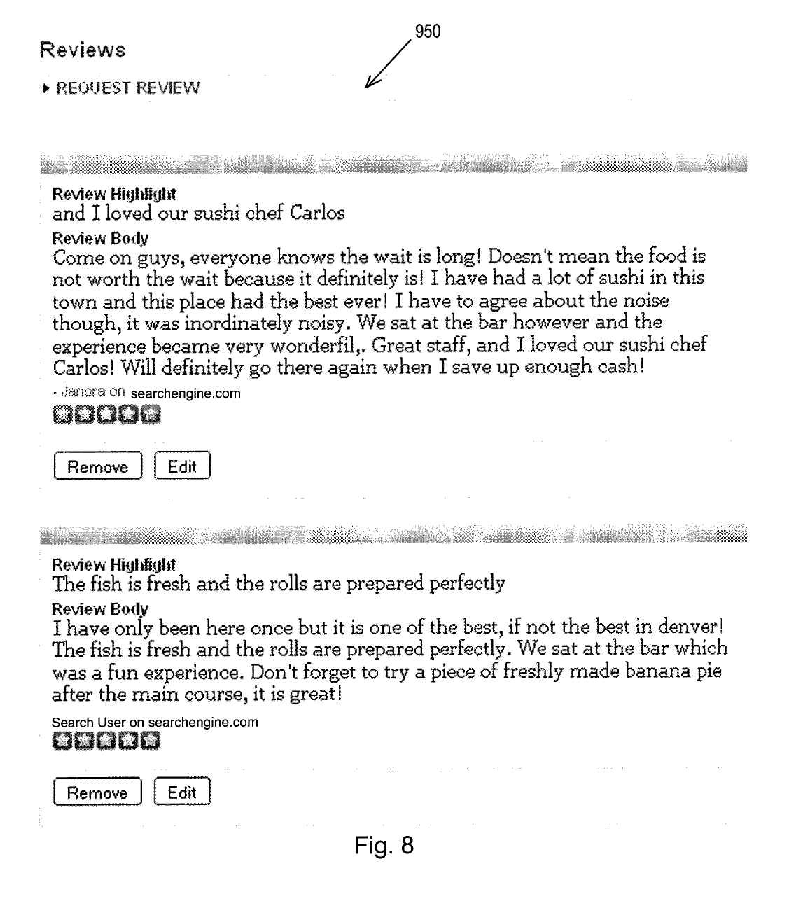

Similarly, in FIG. 8, textual content of screen 950 of a user-generated review is presented to user 220 for editing or deletion. While a user-generated review is shown in FIG. 8, the review could be any type of Review.

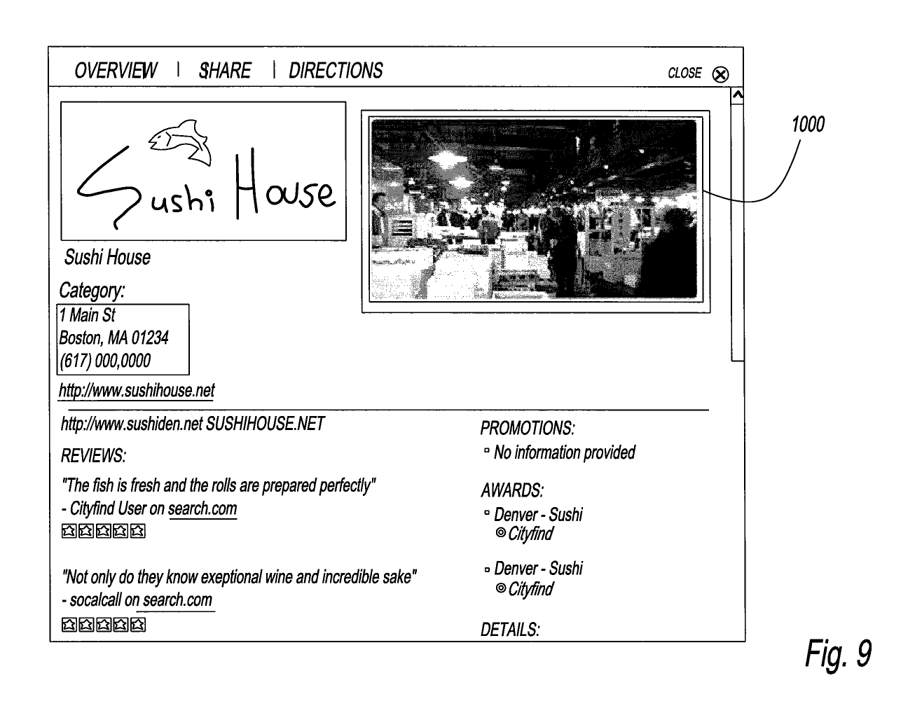

FIG. 9 illustrates a website 1000 that is generated using system 100. Website 1000 contains Business Content that a potential patron would be interested in. This example of Marketing Material is generated by system 100 and presented in a form such as that shown in FIG. 9.

While method 400 is used to generate advertisement 810 and website 1000, other Marketing Materials in general could also be created using the method of the present disclosure. Additionally, method 400 and system 100 have broad applicability to the auto-generation of print and other offline advertisements, websites, and all other forms of Marketing Materials. Further, a restaurant was used in advertisement 810. However, a variety of different topics are appropriate for the generation of Marketing Materials, such as a business, an organization, a product, a creative work, a service, a person, and an event.

The present invention has been described with particular reference to the preferred embodiments. It should be understood that the foregoing descriptions and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

We claim:

1. A method comprising:
searching a computer network using a descriptor for a topic, for a source that may have content concerning said topic;
searching said source for content related to said topic;
filtering said content for information related to said topic to generate filtered information; and
preparing a report using said filtered information if said content includes said filtered information.

2. The method of claim 1 wherein said topic is a business, and wherein said descriptor comprises a name of said business and/or the location of said business.

3. The method of claim 2, wherein said location is a street address, a postal code, a state, a region or any combination thereof.

4. The method of claim 2, wherein said report comprises marketing materials concerning said business.

5. The method of claim 4, wherein said marketing materials comprise a print advertisement, online advertisement, brochure, pamphlet, website, flyer, or video.

6. The method of claim 1, wherein said topic is selected from the group consisting of: a business, an organization, a product, a creative work, a service, a person, or an event.

7. The method of claim 1, wherein said content comprises text, and wherein said filtering comprises obtaining said filtered information related to said topic based on predefined criteria.

8. The method of claim 7, wherein said predefined criteria is based on keywords, phrases, symbols, numbers, sentiments, and/or regular expressions.

9. The method of claim 1, wherein said content comprises audio and visual materials, and wherein said filtering is based on predefined criteria.

10. The method of claim 9, wherein said predefined criteria comprises size, quality, filename, position on a website, file attributes and other metadata.

11. The method of claim 1, wherein said source comprises a first source and a second source.

12. The method of claim 1, wherein said source comprises a plurality of sources.

13. The method of claim 1, wherein said source is selected from the group consisting of a website, a database, structured data feeds, and a stock photograph repository.

14. The method of claim 1, wherein said source is one of a structured database, an unstructured database, or a database that is directly or indirectly available.

15. The method of claim 1, wherein said topic is a business and said content comprises awards, promotions, photos, logos, contact information, industry information, hours of operation, keywords, price ranges, credit cards accepted, business description, other details relating to a business, and stock photography determined to be relevant to a business.

16. The method of claim 1, wherein said content comprises editorial content, including professional reviews, user-generated reviews, aggregate ratings, and rankings.

17. The method of claim 1, wherein said step of searching said sources comprises obtaining information from said source.

18. The method of claim 1, wherein said content comprises text and audio and visual materials, and said text and said audio and visual materials are searched simultaneously.

19. The method of claim 1, wherein said filtered information comprises content that is determined to portray the topic most favorably.

20. The method of claim 7, wherein said text is filtered semantically.

21. The method of claim 7, wherein said text is filtered using quantitative and statistical techniques.

22. The method of claim 9, wherein said audio and visual materials are filtered using image processing techniques.

23. The method of claim 1, wherein said source is a stock content repository, and said descriptor is a characteristic pertaining to the topic.

24. The method of claim 1, further comprising the step of editing said report.

25. The system comprising a processor that performs a method that includes:
a) searching a computer network using a descriptor for a topic, for a source that may have content concerning said topic;
b) searching said source for content related to said topic;
c) filtering said content to obtain filtered information related to said topic; and
d) preparing a report using said filtered information if said content includes said filtered information.

26. The system of claim 25, wherein said processor executes instructions that search said source based on the type of source.

27. The system of claim 25, wherein said processor executes instructions that filter said content using predefined criteria based on the type of content.

28. The system of claim 25, wherein said content comprises text, and wherein said processor filters said text based on predefined criteria.

29. The system of claim 25, wherein said content comprises audio and visual materials, and wherein said processor filters said audio and visual materials based on predefined criteria.

30. The system of claim 25, wherein said source is selected from the group containing a website, a database, structured data feeds, and a stock photograph repository.

31. The system of claim 25, wherein topic is a business and said content comprises awards, promotions, photos, logos, contact information, industry information, hours of operation, keywords, price ranges, credit cards accepted, business description, other details relating to a business, and stock photography determined to be relevant to a business.

32. The system of claim 25, wherein said content comprises editorial content, including professional reviews, user-generated reviews, aggregate ratings, and rankings.

33. The system of claim 25, wherein said step of searching said sources comprises obtaining information from said source

34. The system of claim 28, wherein said predefined criteria comprise keywords, phrases, symbols, numbers, sentiments, and/or regular expressions.

35. The system of claim 28, wherein said text is filtered semantically.

36. The system of claim 28, wherein said processor filter said text semantically using keywords, phrases, symbols, numbers, sentiments, and/or regular expressions.

37. The system of claim 29, wherein said processor filter said audio and visual materials based on quality, size, filename, position on a website, file attributes and other metadata.

38. The system of claim 29, wherein said predefined criteria comprise file size, filename, position on a website, file attributes and other metadata.

39. The system of claim 25, wherein said topic is selected from the group consisting of: a business, an organization, a product, a creative work, a service, a person, and an event.

40. A computer readable storage medium having stored therein instructions that are executable by a processor performing a method comprising:
searching a computer network using a descriptor for a topic, for a source that may have content concerning said topic;
searching said source for content related to said topic;
filtering said content to obtain filtered information related to said topic; and
preparing a report using said filtered information if said content includes said filtered information.
